(19) United States
(12) Patent Application Publication
(10) Pub. No.: US 2008/0110500 A1
(43) Pub. Date: May 15, 2008

(54) Microfluidic Valve Liquids

(75) Inventors: Horacio Kido, Niland, CA (US); Marc J. Madou, Irvine, CA (US); Jim V. Zoval, Lake Forest, CA (US); Jitae Kim, Irvine, CA (US); Guangyao Jia, Irvine, CA (US)

Correspondence Address: Vista IP Law Group LLP, 2040 MAIN STREET, 9TH FLOOR, IRVINE, CA, 92614, US

(73) Assignee: THE REGENTS OF THE UNIVERSITY OF CALIFORNIA, Oakland, CA (US)

(21) Appl. No.: 11/816,843

(22) PCT Filed: Mar. 8, 2006
(86) PCT No.: PCT/US06/08411

§ 371 Date: Aug. 22, 2007

Related U.S. Application Data
(60) Provisional application No. 60/660,060, filed on Mar. 9, 2005.

(51) Int. Cl. F15C 1/04

(52) U.S. Cl. 137/8; 137/829; 137/2

(57) ABSTRACT

A microfluidic device for the splitting or sequencing of fluid flow includes a plurality of upstream and/or downstream chambers coupled via microfluidic channels. For splitting fluid, a substrate is provided that includes a main chamber and a plurality of downstream sub-chambers. Each sub-chamber is associated with a sealable vent hole. Fluid is selectively moved into the desired sub-chamber of interest by unsealing its associated vent hole. Fluid is then pumped into the sub-chamber, for example, by rotating the substrate. For flow sequencing, a substrate is provided that includes a plurality of upstream chambers coupled to at least one downstream chamber. Each upstream chamber has an associated vent hole that can be selectively opened. The substrate is then rotated and fluid contained in the upstream chamber with the valve in the unsealed state will then pass to the at least one downstream chamber.

### REFERENCE TO RELATED APPLICATIONS

This application claims priority to U.S. Provisional Patent Application No. 60/660,060 filed on Mar. 9, 2005. U.S. Provisional Patent Application No. 60/660,060 is incorporated by reference as if set forth fully herein.

### FIELD OF THE INVENTION

The field of the invention generally relates to microfluidic devices and methods used to gate or switch fluids into different flow paths, channels, or chambers. More specifically, the field of the invention relates to microfluidic valves embedded in a microfluidic device such as a microfluidic compact disc (CD) for liquid splitting or flow sequencing.

### BACKGROUND OF THE INVENTION

Microfluidic devices are becoming increasingly more important in both research and commercial applications. Microfluidic devices, for example, are able to mix and react reagents in small quantities, thereby minimizing reagent costs. These same microfluidic devices also have a relatively small size or footprint, thereby saving on laboratory space. Microfluidic devices are increasingly being used in clinical applications. Finally, because of their small scale, microfluidic devices are able to quickly and cost effectively synthesize products which can be later used in research and/or commercial applications.

Lee valves and capillary valves have been used to gate liquids in microfluidic systems. However, the fabrication process of mechanical valves is generally complicated and costly. In addition, external supporting systems (e.g., power supply, air pressure lines and sources) may be necessary to actuate the valves. While the fabrication process is not a major issue for capillary valves, the reliability of such capillary valves is not satisfactory. For example, the performance of the valves is highly dependent on the dimensions of the channels and the surface properties (e.g., contact angle) of the materials. In addition, in some cases the dimensions of the valves are not adjustable (for a wide range of flow rates) and the surface properties of the valve materials are not well determined. There thus is a need for a reliable yet cost-effective valve usable in microfluidic-based devices.

### SUMMARY OF THE INVENTION

In a first aspect of the invention, a microfluidic device is provided for liquid gating in microfluidic systems. In one aspect of the invention, the liquid gating function is implemented on a rotating or centrifugal-based microfluidic device such as, for example, a rotatable compact disc (CD) or the like having formed therein the requisite inlets, outlets, chambers, and vents. Of course, the present invention may be implemented using other pumping forces beyond the centrifugal force. For example, liquid may be pumped or otherwise moved using pneumatic pumping, mechanical pumping, electroosmotic pumping, and the like.

In yet another aspect of the invention, the microfluidic device may be used to split or selectively dispense a fluid such as a liquid from a main chamber into one or more downstream chambers (e.g., sub-chambers) coupled to the main chamber. Fluid is directed to the appropriate destination sub-chamber by opening or otherwise providing access to a valved vent hole associated with the particular sub-chamber of interest.

In still another aspect of the invention, the microfluidic device may be used to selectively sequence the flow of liquid(s) contained in a plurality of source chambers to one or more common destination chambers. The sequence of flow is effectuated by selectively opening or otherwise providing access to a valved vent hole associated with the particular source chamber of interest. The sequence or order in which the valved vent holes are opened determines the sequence of flow of the liquid(s).

In one embodiment of the invention, a microfluidic device includes a substrate, a main chamber disposed in the substrate, a plurality of sub-chambers disposed in the substrate and coupled to the main chamber, wherein each sub-chamber has or is associated with a vent hole (e.g., through a microfluidic channel). Each vent hole has a valve member for sealing the respective vent hole. The valve member is preferably substantially impermeable to gases. In certain embodiments, the valve member is removable. The valve member may be formed from an adhesive member or, for example, a barrier such as a septum.

In still another aspect of the invention, means for unsealing the vent hole is provided. The means may be operated manually or automatically. For example, the means for unsealing the vent hole may include a puncturing device that is adapted to puncture or pierce the valve member. Alternatively, the means for unsealing the vent hole may include a laser or radiation beam. In still another embodiment of the invention, the means for unsealing the vent hole may include a tool or other device for manually opening the vent hole.

The main chamber of the microfluidic device may include one or more vent holes and/or inlets that can be used to fill or load fluid(s) within the main chamber. Alternatively, the main chamber of the microfluidic device may be coupled to one or more microchannels. In this regard, the main chamber may be integrated into a microfluidic device or system capable of performing several processes (e.g., sample preparation, separation, reaction, elution, and the like).

In another aspect of the invention, the microfluidic device is formed on a compact disc (CD). The CD can then be rotated about a rotational axis to pump fluid from one chamber to another based on the centrifugal forces imparted upon the liquid(s). For example, the sub-chambers may be disposed in the CD at a location or distance that is radially outward from the main chamber. In this orientation, fluid is able to flow from the main chamber to the sub-chambers. Individual sub-chambers may be chosen as the destination chamber of interest by opening (or closing as the case may be) respective vent holes associated with sub-chambers.

In still another aspect of the invention, a microfluidic device includes a substrate that is rotatable about an axis of rotation. The device includes a plurality of upstream chambers disposed in the substrate, each chamber being coupled to a vent hole and a valve member for sealing the respective vent hole. At least one downstream chamber is disposed in the substrate and is coupled to the plurality of chambers, wherein the at least one downstream chamber is located radially outward with respect to the plurality of upstream chambers.

In accordance with one aspect of the invention, the microfluidic device described immediately above includes a valve member that is removable. For example, the valve member may be formed from an adhesive material. In other embodiments, the valve member may be formed as a barrier or septum. In either case, the valve member is substantially impermeable to gases. Various means for unsealing the vent hole may be used. For instance, a puncturing device, laser, or tool may be used to unseal the vent hole. Where the valve member is formed of an adhesive material such as an adhesive tape, the tape may simply be removed by an operator.

In one aspect of the invention, the substrate is formed as a CD which is rotatable about an axis of rotation. The CD may be rotated using a rotatable platen or spindle to provide the centrifugal pumping force. The platen or spindle may, in turn, be coupled to a motor or servo.

In yet another aspect of the invention, a method of splitting fluid in a microfluidic device includes the steps of providing a microfluidic device including a substrate having a main chamber disposed in the substrate containing a fluid and a plurality of sub-chambers disposed in the substrate containing a fluid, wherein the sub-chambers are coupled to the main chamber and each sub-chamber has a vent hole with a valve member for sealing the vent hole. The vent hole is then unsealed from one of the sub-chambers. The substrate is then rotated about an axis to transfer at least a portion of the fluid from the main chamber into the sub-chamber having the unsealed vent hole. After transfer, the vent hole may be resealed. A vent hole associated with another sub-chamber may then be unseated. The substrate is then rotated a second time to transfer fluid to the second sub-chamber.

In still another aspect of the invention, a method of sequencing the flow of a fluid in a microfluidic device includes the steps of providing a microfluidic device having a rotatable substrate and a plurality of upstream chambers disposed in the substrate containing a fluid, each chamber being coupled to a vent hole and a valve member for sealing the respective vent hole, and at least one downstream chamber disposed in the substrate and coupled to the plurality of chambers. The at least one downstream chamber is located radially outward with respect to the plurality of upstream chambers. A vent hole of one of the plurality of upstream chambers is then unsealed. The substrate is then rotated about an axis so as to transfer at least a portion of the fluid from the upstream chamber having the unsealed vent hole to the at least one downstream chamber.

A vent hole of another upstream chamber may then be unsealed and the substrate rotated to transfer fluid from the second upstream chamber to the at least one downstream chamber. This sequence may be repeated for each of the plurality of upstream chambers. The sequence of flow is controlled by the order in which the vent holes of the upstream chambers are unsealed.

It is thus an object of the invention to provide a device and method capable of gating liquid flow into one or more downstream chambers or channels. In one object of the invention, a method and device is provided for selectively splitting fluid into multiple, downstream chambers (e.g., sub-chambers). Selectivity is provided by selectively unsealing vent holes associated with each of the downstream chambers. It is still another object of the invention to provide a method and device for selectively sequencing the flow of a fluid contained in multiple chambers to a common downstream chamber. Selectivity is provided by selectively unsealing vent holes associated with each upstream chamber. Further features and advantages will become apparent upon review of the following drawings and description of the preferred embodiments.

### BRIEF DESCRIPTION OF THE DRAWINGS

FIG. 1 illustrates a microfluidic device used to selectively dispense or gate the flow of a fluid into a microfluidic chamber. FIG. 1 illustrates a microfluidic feature disposed on a rotatable substrate in the form of a compact disc (CD).

FIG. 2 illustrates a microfluidic device according to one embodiment of the invention. The microfluidic device includes a main chamber (Chamber 1) and a plurality of sub-chambers (Chambers 2, 3, 4) coupled the main chamber. Each sub-chamber includes an associated vent hole and valve member for selectively unsealing the vent hole. The microfluidic device according to this embodiment is used to selectively split fluid into multiple downstream chambers (e.g., sub-chambers).

FIG. 3 illustrates a microfluidic device according to an alternative embodiment of the invention. The microfluidic device includes a plurality of upstream chambers (Chambers 1, 2, 3) each chamber being coupled to a vent hole having a valve member for sealing the respective vent holes. The plurality of upstream chambers are coupled to at least one downstream chamber (chambers 4 and 5) located radially outward from the upstream chambers (e.g., toward the rim of the device). The microfluidic device according to this embodiment is used to selectively sequence the flow of a fluid from the plurality of upstream chambers to the at least one downstream chamber.

FIG. 4 illustrates a process flowchart for fabricating a rotationally driven substrate using a PDMS molding technique.

FIG. 5 illustrates a system for rotating a substrate containing a switch. FIG. 5 also illustrates an optional imaging system than may be used.

### DETAILED DESCRIPTION OF THE PREFERRED EMBODIMENTS

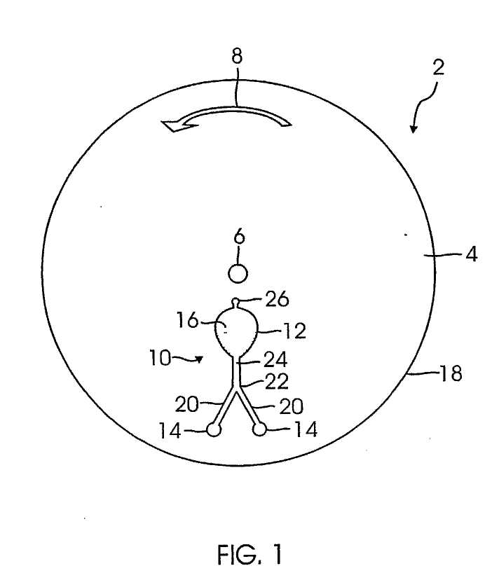

FIG. 1 illustrates a microfluidic device 2 according to one aspect of the invention. The microfluidic device 2 is formed on a substrate 4. The substrate 4 may comprise any number of materials known to those skilled in the art for use with microfluidic structures. In one aspect of the invention, the substrate 4 is a laminated structure formed from a PDMS layer sandwiched between two polycarbonate discs using a pressure-sensitive adhesive film (described in more detail below). In one aspect, the substrate 4 is rotatable about an axis of rotation 6. FIG. 1 illustrates a substrate 4 in the form of a compact disc (CD). FIG. 1 shows the substrate 4 rotating about an axis of rotation 6 in the counter-clockwise direction (represented by arrow 8). It should be understood, however, the substrate 4 is rotatable in either the counter-clockwise or clockwise directions.

Still referring to FIG. 1, the microfluidic device 2 includes one or more microfluidic features 10 contained in the substrate 4. The microfluidic features 10 may include, by way of example, chambers, channels, junctions, inlets, outlets, vents, and the like. The feature illustrated in FIG. 1 has main chamber 12 and two downstream chambers 14. The chambers 14 are referred to as being “downstream” because during rotation of the substrate 4, centrifugal forces push fluid 16 contained in the main chamber 12 radially outward toward the rim 18 of the device 2. These downstream chambers 14 may also be referred to as sub-chambers. In the device 2 of FIG. 1, the main chamber 12 is coupled to the two downstream chambers 14 via microfluidic channels 20 that join an a junction point 22. The junction point 22, in turn, is coupled to the main chamber 12 via another microfluidic channel 24. It should be understood that the two downstream chambers 14 may be coupled directly to the main chamber 12.

The main chamber 12 may include an inlet 26 that can be used to load the main chamber 12 with a fluid 16. In addition, in certain embodiments of the invention, the inlet 26 may also double as a vent such that the interior of the main chamber 12 can communicate with ambient conditions outside the device 2. Similarly, in one embodiment of the invention, the two downstream chambers 14 contain or are associated with vent holes (not shown) that are described in more detail below. The vent holes may be located directly in the downstream chamber 14, or alternatively, the vent holes may be coupled to the chambers 14 via a microfluidic channel. As described below, the vent holes have valve members for selectively sealing (or unsealing) the respective chambers 14.

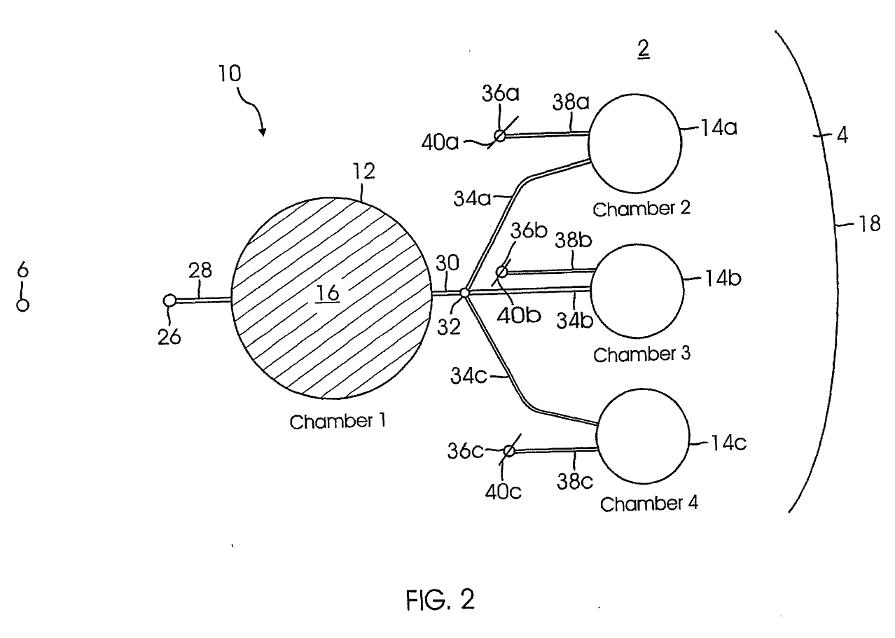

Turning now to FIG. 2, a close-up view of a microfluidic feature 10 according to one embodiment of the invention is shown. In this embodiment, like the embodiment illustrated in FIG. 1, a main chamber 12 (identified as chamber 1 in FIG. 2) is coupled to a plurality of downstream sub-chambers 14a, 14b, 14c (chambers 2, 3, and 4 in FIG. 2). The main chamber 12 is fluidically coupled via a microfluidic channel 28 to an inlet 26. The inlet 26 may be used to load fluid 16 (e.g., liquid) into the main chamber 12. The main chamber 12 is also connected to an outlet microfluidic channel 30 that terminates at a junction 32. The junction 32 is further coupled to a plurality of microfluidic channels 34a, 34b, 34c that connect to sub-chambers 14a, 14b, 14c. Each sub-chamber 14a, 14b, 14c includes a respective vent hole 36a, 36b, 36c. As seen in FIG. 2, the vent holes 36a, 36b, 36c are coupled to their respective sub-chambers 14a, 14b, 14c via microchannels 38a, 38b, 38c. Alternatively, the vent holes 36a, 36b, 36c may be positioned directly on or in the sub-chambers 14a, 14b, 14c.

Still referring to FIG. 2, each vent hole 36a, 36b, 36b includes a valve member 40a, 40b, 40c for sealing the respective vent holes 36a, 36b, 36b. The valve members 40a, 40b, 40c generally operate by blocking or obstructing a passageway or orifice of the vent hole 36a, 36b, 36c. The valve members 40a, 40b, 40c are substantially impermeable to gases. In the closed or sealed state, the valve members 40a, 40b, 40c thus provide a barrier between the interior of the sub-chambers 14a, 14b, 14c and the outside environment. In one aspect of the invention, the valve members 40a, 40b, 40c are removable. That is to say, the valve members 40a, 40b, 40c may altered or repositioned to provide access between the interior of the sub-chambers 14a, 14b, 14c and the outside environment. For example, the valve members 40a, 40b, 40c may comprise a plug or the like that may be removed from the respective vent holes 36a, 36b, 36c. Alternatively, the valve members 40a, 40b, 40c may be formed from an adhesive member such as a tape having one side layered with an adhesive material. The adhesive member may be removed by simply peeling off the same from the substrate 4.

In still another aspect of the invention, the valve members 40a, 40b, 40c may be formed as a barrier or septum that is disposed on top of or inside the vent holes 36a, 36b, 36c. Various means for unsealing the valve members 40, 40b, 40c may also be employed. For instance, a puncturing device having a sharpened or pointed tip may be used to puncture or otherwise pierce the valve members 40a, 40b, 40c. Alternatively, the valve members 40a, 40b, 40c may be unsealed by a focused radiation beam such as, for instance, a laser. Light emitted from the laser could selectively ablate or create a hole within the valve members 40a, 40b, 40c to thereby provide access to the interiors of the sub-chambers 14a, 14b, 14c. In yet another embodiment, a tool or the like may be used to unseal the valve members 40a, 40b, 40c. The tool may be manually or even automatically controlled through the use of robotic control to unseal the valve members 40a, 40b, 40c.

Still referring to FIG. 2, the feature 10 is formed on a substrate 4 such as CD that rotates about a axis 6. The main chamber 12 is located radially inward or upstream of the downstream sub-chambers 14a, 14b, 14c. The feature shown in FIG. 2 may be used to split or selectively allocate fluid 16 to one or more downstream sub-chambers 14a, 14b, 14c. For example, fluid 16 may be first loaded into the main chamber 12 via the inlet 26. The vent hole associated with the desired destination chamber is then unsealed. For example, if sub-chamber 14a (chamber 2) is the initial destination chamber of choice, the vent hole 36a associated with this sub-chamber 14a is unsealed using one of the methods described above. The remaining vent holes 36b, 36c remain in a sealed state. The substrate 4 is then rotated about the axis 6. By rotating the substrate 4 about its axis 6, centrifugal forces act upon the liquid 16 in the main chamber 12 force or move the fluid 16 into sub-chamber 14a. In the device shown in FIG. 2, the fluid 16 can only flow to the unsealed sub-chamber 14a. This is due to the fact that the pumping force on the fluid 16 is balanced by the air pressure built up in the sealed sub-chambers 14b, 14c. When the fluid 16 is pushed toward these sub-chambers 14b, 14c, the flow is stopped by the pressure that results because the vent holes 36b, 36c are closed. Therefore, the fluid 16 in the main chamber 12 (chamber 1) can be pumped only into the sub-chamber 14a—the sub-chamber that is open to the atmosphere.

After at least some of the fluid 16 has been pumped or transferred to sub-chamber 14a, the substrate 4 may be stopped. In one aspect of the invention, the vent hole 36a may be resealed, e.g., using a valve member 40a such as an adhesive tape. In order to transfer fluid 16 to a next sub-chamber (e.g., sub-chamber 14b), the vent hole 36b associated with this sub-chamber 14b is unsealed. The other vent holes 36a, 36c are in a sealed state. The substrate 4 is then rotated about its axis 6 again and fluid 16 is forced or pumped into the sub-chamber 14b. It should be understood that the fluid 16 in the main chamber 12 may be pumped into the sub-chamber 14a, 14b, 14c of interest in any desired order by sealing the vent holes 36a, 36b, 36c of the remaining sub-chambers that are not intended to be filled.

While the device in FIG. 2 has been described operating in connection with a rotatable substrate 4 to provide a centrifugal pumping force, alternative pumping sources may be employed to move or pump fluid 16 within the device 2. These include, for example, pneumatic pumping, mechanical pumping, electroosmotic pumping, and other techniques known to those skilled in the art.

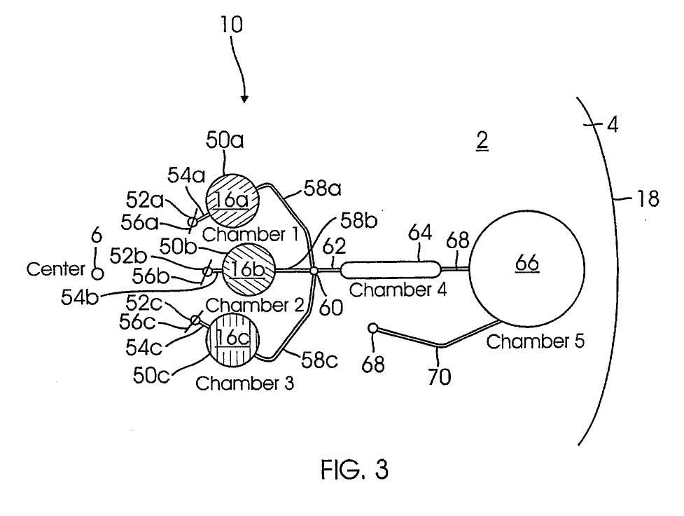

FIG. 3 illustrates a microfluidic feature 10 according to an alternative embodiment of the invention. This embodiment illustrates a microfluidic device 2 used to sequence flow of a liquid from multiple sources into one or more common chambers. As seen in FIG. 3, a microfluidic device 2 includes a substrate 4 rotatable about an axis 6. As with the embodiment illustrated in FIG. 2, the substrate 4 may be formed as a CD. The device includes a plurality of upstream chambers 50a, 50b, 50c (e.g., chambers 1, 2, 3 shown in FIG. 3) located on or within the substrate 4. Each chamber 50a, 50b, 50c may include the same or different fluids 16a, 16b, 16c. In one aspect of the invention, each chamber 50a, 50b, 50c may include a different liquid reagent. In yet another embodiment, one chamber may contain an analyte while another chamber may contain a binding agent. A remaining chamber may include a washing or eluting fluid.

Still referring to FIG. 3, each upstream chamber 50a, 50b, 50c is coupled to a vent hole 52a, 52b, 52c, respectively. The chambers 50a, 50b, 50c may be coupled directly to the vent hole 52a, 52b, 52c directly or via microfluidic channels 54a, 54b, 54c as shown in FIG. 3. In certain embodiments, the vent holes 52a, 52b, 52c may double as inlets that can be used to fill the respective chambers 50a, 50b, 50c with fluid 16. Each vent hole 52a, 52b, 52c includes a valve member 56a, 56b, 56c for sealing the respective vent holes 52a, 52b, 52c. The valve members 56a, 56b, 56c may be constructed as disclosed above with respect to the embodiment illustrated in FIG. 2.

Each upstream chamber 50a, 50b, 50c is coupled to a microfluidic channel 58a, 58b, 58c that terminates into a junction 60. The junction 60 is coupled to another microfluidic channel 62 that terminates into a first downstream chamber 64 (chamber 4 as shown in FIG. 3). As seen in FIG. 3, the first downstream chamber 64 is coupled to a second downstream chamber 66 (chamber 5 in FIG. 3) via microfluidic channel 68. The second downstream chamber 66 is coupled to a vent hole 68 via a microfluidic channel 70. In certain embodiments of the invention, the vent hole 68 may also be used as an outlet that can be used to withdraw or remove fluid 16 contained inside the chamber 66.

Referring to FIG. 3, operation of the device will now be described. One or more fluids (e.g., liquids 16a, 16b, 16c) are contained in the upstream chambers 50a, 50b, 50c. The sequence of flow of the fluids 16a-16c to the downstream chambers 64, 66 can then be selectively controlled by unsealing the vent hole 52a, 52b, 52c of the upstream chamber that is to be emptied. For example, in the case of the device shown in FIG. 3, assume that flow sequencing occurs first from chamber 50a (chamber 1) then to chamber 50b (chamber 2) and finally to chamber 50c (chamber 2). Initially, the vent hole 52a associated with chamber 50a is unsealed while the remaining vent holes 52b, 52c remain sealed. The substrate 4 is then rotated about an axis 6 to forcibly push or pump the fluid 16a through microchannel 58a to the junction 60 where the fluid 16a continues into the first downstream chamber 64. The fluid 16a then continues onward down the microchannel 68 and into the second downstream chamber 66.

Flow from the second upstream chamber 50b is initiated by unsealing its associated vent hole 52b. The vent hole 52b may be unsealed using any of the methods and devices described herein. In one embodiment, the vent hole 52b is unsealed by removing, puncturing/piercing, or even destroying a valve member 56b associated with the vent hole 52b. The vent hole 52b may be opened while the substrate 4 is rotating or, alternatively, the substrate 4 may be temporarily stopped to open the vent hole 52b. Flow of fluid 16b from chamber 50b then passes to the first and second downstream chambers 64, 66 by rotating the substrate 4. Fluid from the third chamber 50c is then initiated by unsealing the vent hole 52c associated with the third chamber 50c. The substrate 4 is rotated to then force the fluid 16c out of the chamber 50c and into the downstream chambers 64, 66. It should be understood, that the entire contents of a particular chamber 50a, 50b, 50c need not be completely evacuated during rotation of the substrate 4. For example, the vent hole 52a, 52b, 52c associated with a particular chamber may be resealed to prevent complete evacuation of fluid 16a, 16b, 16c.

The device shown in FIG. 3 operates by restraining or preventing radial flow of fluid 16a, 16b,16c from those chambers 50a, 50b, 50c that are sealed with respect to the external environment. Fluid flow from the chambers 50a, 50b, 50c that are sealed is prevented because the centrifugal pumping force is balanced by the generated vacuum force within the sealed chamber. Therefore, only fluids 16a, 16b, 16c in the chambers 50a, 50b, 50c that are unsealed and open to the atmosphere via the vent hole 52a, 52b, 52c will flow outwardly in the radial direction toward the downstream chambers 64, 66. Because a vacuum force is used to restrict the flow of liquid 16, this embodiment is referred to as “negative valving.”

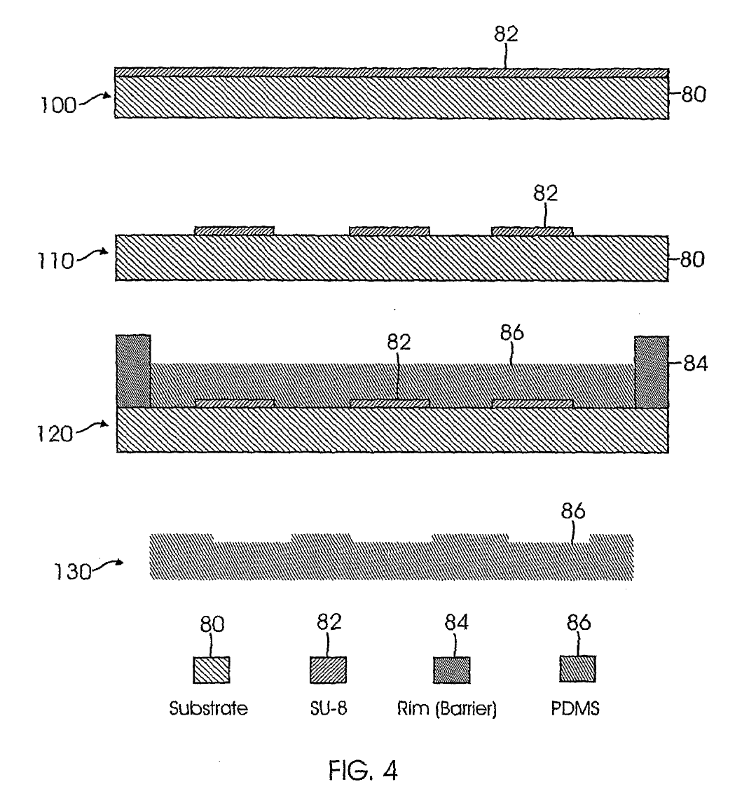

FIG. 4 illustrates one method of forming substrate 4 having a microfluidic feature 10 like those disclosed in FIGS. 2 and 3 formed therein. The method illustrated in FIG. 4 uses a molded elastomer to form the microfluidic features (e.g., chambers, junctions, channels, vents, etc.). It should be understood, however, that other fabrication techniques known to those skilled in the microfluidic arts may be used to one or more features 10 on a rotatable substrate 4. For example, Computer Numerical Control (CNC) machining may be used to fabricate the devices. Alternatively, microfluidic patterns may be photographically etched in a dry film resist that is laminated between two outer plastic discs.

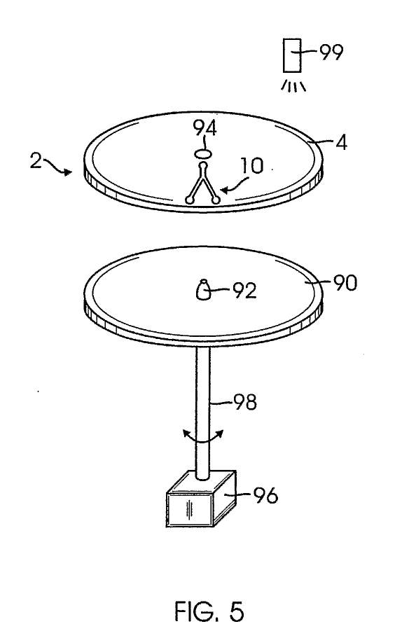

Referring to FIG. 5, in step 100 a substrate 80 such as a Silicon wafer is provided and a negative tone photoresist 82 such as SU-8 (NANO SU-8 available from MicroChem, Corp., Newton, Mass.) is deposited on an upper surface of the substrate 80 by spin coating. The substrate 80 (with SU-8) is then subject to a pre-baking process to evaporate the solvent and densify the film. For example, for a 100 μm thickness, the substrate 80 is heated at around 65° C. for around 10 minutes. A typical thickness for the first application of photoresist 82 is around 160 μm.

After pre-baking, a mask is interposed between the substrate 80 and a UV light source (not shown) to expose selective portions of the photoresist 82. Typical wavelengths usable to cross-link SU-8 fall within the range of about 350 nm to about 400 nm. The UV light serves to initiate cross-linking certain portions of the photoresist 82 that will ultimately become the microfluidic features 10. The substrate 80 then undergoes a post-exposure bake heating operation wherein the substrate 80 is heated to around 65° C. for several minutes, and then to around 95° C. for twelve minutes (for a photoresist having a thickness of 150 μm) to fully crosslink the UV-exposed photoresist 82.

Next, as seen in step 110, the substrate 80 is immersed in a developing or etching solution (available from MicroChem Corp.) to remove the unexposed areas of the photoresist 82. Actual developing time depends on the thickness of the photoresist 82. For a photoresist layer 82 having a 150 μm thickness, the immersion time is around 15 to 20 minutes. Other solvent-based developing solutions that may be used include ethyl lactate and diacetone alcohol. For high aspect ratio structures, agitation of the solution may be required.

Now referring to step 120, the substrate 80 is placed into a holding ring 84 that includes a circumferential rim that acts as a barrier to retain the polydimethylsiloxane (PDMS) precursor over the top of the substrate 80. The PDMS precursor along with a curing agent (e.g., Sylgard 185, Dow Corning, Midland, Mich.) are then mixed thoroughly in a weight ratio of 10:1, respectively. After degassing the mixture in vacuum, the mixture is poured and cured on the SU-8 master mold. The mold may be heated to accelerate the curing process.

As seen in step 130, after curing, the PDMS layer 86 containing the microfluidic features is then peeled off the master mold. To form the complete substrate 4, the PDMS layer 86 is then sandwiched between two polycarbonate discs using a pressure-sensitive adhesive film.

FIG. 5 illustrates an apparatus used to rotate the now formed substrate 4. The apparatus includes a support or platen 90 on which the substrate 4 rests. The platen 90 is rotational about its central axis in either the clockwise or counter-clockwise directions. In one embodiment, the platen 90 may have a spindle 92 that passes partially or completely through a hole 94 formed in the substrate 4. The platen 90 may be connected to a motor or servo 96 via a shaft 98 that is used to drive the platen 90 and thus the substrate 4. The motor or servo 96 may be a bi-directional such that platen 90 is able to spin in either the clockwise or counter-clockwise directions. In addition, the speed of the motor or servo 96 may be controllable such that the angular rotational frequency can be controlled. For example, the motor or servo 96 may be connected to a computer such as a PC (not shown) that can control the rotational parameters (e.g., rotational speed, sequence, timing, etc.).

Still referring to FIG. 5, an imaging system 99 may be incorporated into the system. The imaging system 99 may include, for example, a radiation source used to fluoresce one or more components within the fluid 16. Alternatively, the imaging system 99 may include a radiation source that is capable of unsealing a vent hole, for example, by puncturing or destroying a valve member (40, 56) associated with a particular vent hole (36, 52). The imaging system 99 may also include imaging means such as, for instance, a camera or charged coupled device (CCD) or the like that can be used to selectively view one or more regions of the substrate 4 (e.g., downstream chambers 64, 66). In addition, the imaging system 99 may include image analysis software that is used in the automatic analysis and detection of certain species or components contained within the fluid 16.

While embodiments of the present invention have been shown and described, various modifications may be made without departing from the scope of the present invention. The invention, therefore, should not be limited, except to the following claims, and their equivalents.

What is claimed is:

1. A microfluidic device comprising:
a substrate;
a main chamber disposed in the substrate;
a plurality of sub-chambers disposed in the substrate and coupled to the main chamber, each sub-chamber having a vent hole; and
wherein each vent hole has a valve member for sealing the respective vent hole.

2. The microfluidic device of claim 1, wherein the valve member is removable.

3. The microfluidic device of claim 2, wherein the valve member comprises an adhesive member.

4. The microfluidic device of claim 1, wherein the valve member comprises a septum.

5. The microfluidic device of claim 1, wherein the valve member is substantially impermeable to gases.

6. The microfluidic device of claim 1, further comprising means for unsealing the vent hole.

7. The microfluidic device of claim 6, wherein the means for unsealing the vent hole comprises a puncturing device adapted for puncturing the valve member.

8. The microfluidic device of claim 6, wherein the means for unsealing the vent hole comprises a laser.

9. The microfluidic device of claim 1, wherein the means for unsealing the vent hole comprises a tool.

10. The microfluidic device of claim 1, further comprising an inlet coupled the main chamber.

11. The microfluidic device of claim 1, wherein the plurality of sub-chambers are coupled to the main chamber via microchannels.

12. The microfluidic device of claim 1, wherein the substrate comprises a rotatable substrate.

13. The microfluidic device of claim 12, wherein the substrate comprises a compact disc (CD).

14. The microfluidic device of claim 12, wherein the plurality of sub-chambers are located radially outward from the main chamber.

15. The microfluidic device of claim 12, further comprising means for rotating the rotatable substrate.

16. A microfluidic device comprising:
a substrate rotatable about an axis of rotation;
a plurality of upstream chambers disposed in the substrate, each chamber being coupled to a vent hole and a valve member for sealing the respective vent hole; and
at least one downstream chamber disposed in the substrate and coupled to the plurality of chambers, the at least one downstream chamber being located radially outward with respect to the plurality of upstream chambers.

17. The microfluidic device of claim 16, wherein the valve member is removable.

18. The microfluidic device of claim 17, wherein the valve member comprises an adhesive member.

19. The microfluidic device of claim 16, wherein the valve member comprises a septum.

20. The microfluidic device of claim 16, wherein the valve member is substantially impermeable to gases.

21. The microfluidic device of claim 16, further comprising means for unsealing the vent hole.

22. The microfluidic device of claim 21, wherein the means for unsealing the vent hole comprises a puncturing device adapted for puncturing the valve member.

23. The microfluidic device of claim 21, wherein the means for unsealing the vent hole comprises a laser.

24. The microfluidic device of claim 21, wherein the means for unsealing the vent hole comprises a tool.

25. The microfluidic device of claim 16, wherein the vent holes comprise inlets.

26. The microfluidic device of claim 16, wherein the plurality of upstream chambers are coupled to the at least one downstream chamber via microchannels.

27. The microfluidic device of claim 16, wherein the substrate comprises a compact disc (CD).

28. The microfluidic device of claim 16, further comprising means for rotating the rotatable substrate.

29. A method of splitting fluid in a microfluidic device comprising:
providing a microfluidic device including a substrate having a main chamber disposed in the substrate containing a fluid, a plurality of sub-chambers disposed in the substrate and coupled to the main chamber, each sub-chamber having a vent hole wherein each vent hole has a valve member for sealing the respective vent hole;
unsealing the vent hole of one of the plurality of sub-chambers; and
rotating the substrate about an axis of rotation so as to transfer at least a portion of the fluid from the main chamber to the sub-chamber having the unsealed vent hole.

30. The method of claim 29, wherein the vent hole is unsealed by removing the valve member.

31. The method of claim 29, wherein the vent hole is unsealed by destroying the valve member.

32. The method of claim 29, wherein the vent hole is unsealed by puncturing the valve member.

33. The method of claim 29, further comprising the step of resealing the vent hole.

34. The method of claim 33, further comprising the step of unsealing a vent hole from another one of the plurality of chambers and rotating the substrate about an axis of rotation so as to transfer at least a portion of the fluid from the main chamber to the sub-chamber having the unsealed vent hole.

35. A method of sequencing the flow of a fluid in a microfluidic device comprising:
providing a microfluidic device having a substrate rotatable about an axis of rotation, a plurality of upstream chambers disposed in the substrate containing fluid, each chamber being coupled to a vent hole and a valve member for sealing the respective vent hole, and at least one downstream chamber disposed in the substrate and coupled to the plurality of chambers, the at least one downstream chamber being located radially outward with respect to the plurality of upstream chambers;
unsealing the vent hole of one of the plurality of upstream chambers; and
rotating the substrate about an axis of rotation so as to transfer at least a portion of the fluid from the upstream chamber having the unsealed vent hole to the at least one downstream chamber.

36. The method of claim 35, wherein the vent hole is unsealed by removing the valve member.

37. The method of claim 35, wherein the vent hole is unsealed by destroying the valve member.

38. The method of claim 35, wherein the vent hole is unsealed by puncturing the valve member.

39. The method of claim 29, further comprising the step of resealing the vent hole.

40. The method of claim 33, further comprising the step of unsealing a vent hole from another one of the plurality of chambers and rotating the substrate about an axis of rotation so as to transfer at least a portion of the fluid from the main chamber to the sub-chamber having the unsealed vent hole.
